(19) United States
(12) Patent Application Publication
(10) Pub. No.: US 2002/0134295 A1
(43) Pub. Date: Sep. 26, 2002

(54) Amphibious Trailer

(76) Inventor: Paul A. Chimato, W. Melbourne, FL (US)

Correspondence Address: David A. Lundy, 825 Anthony Wayne Building, 203 E. Berry Street, Fort Wayne, IN, 46802, US

(21) Appl. No.: 09/813,084

(22) Filed: Mar. 20, 2001

(51) Int. Cl. B60P 3/10; B63C 13/00

(52) U.S. Cl. 114/344; 280/414.1

(57) ABSTRACT

A new and improved amphibious unit comprising a float, a trailer frame, and a camper, all interconnected with one another. The float has a top and a bottom, and the trailer frame may be secured to the bottom of the float or it may be an integral part of the float. The trailer frame generally has a tongue and hitch for connecting the unit to a vehicle for transportation over land. The camper is secured to the top of the float, the camper comprising a dwelling operable for camping purposes, including accommodations as sparse or as lavish as appropriate for the overall design of the amphibious unit. The camper may be a conventional pop-up style camper, or it may be a multi-walled structure with a roof and windows for enclosing the living space of the interior of the camper.

### BACKGROUND OF THE INVENTION

The present invention pertains to a recreational trailer and more particularly to a recreational trailer that combines a camper, boat, and trailer frame with a hitch into one product, so that it may be used on land or on water, and may be transported over land, without the need for costly and/or time consuming additional accessories.

Enjoying the great outdoors can be achieved in several ways. Many people enjoy camping. Camping can be done simply with tents around a campsite or with campers that either are vehicles, such as RVs, or are trailer campers that are trailed to the campsite, having been hitched to a vehicle used to travel there. Campers of either type can be sparse or lavish with regard to the worldly amenities that are provided for campsite living. Sleeping arrangements can include slide-out style beds to conserve space for daytime activities in the camper. They can also include fold out couch beds to increase the functionality of elements provided in the camper unit. Other amenities of campers also include sinks, toilets, showers, stoves, generators, refrigerators, and the list goes on.

Many times people who go camping bring boats with them to enjoy navigating the several lakes, rivers, and other bodies of water that maybe accessible to campers. Unless the boat is inflatable, collapsible, or otherwise capable of being contained in or mounted onto a vehicle used to travel to a campsite, such boats are generally mounted on trailers that are hitched to vehicles for transportation to the campsite. As a result, those who go camping who wish to bring such boats with them to the campsite need to have not only the boat but also the trailer to transport it with. In the event that the people on a camping trip are utilizing a trailer camper, they are precluded from additionally bringing a boat that requires a trailer for transportation in those states prohibiting tandem trailers, unless an additional vehicle is brought to the campsite. In any event, people who go camping who use campers or tents, and who prefer to bring a boat for recreational activity, must own, purchase, or lease at least three separate items. Therefore, it is highly desirable to provide a new and improved amphibious unit that combines the boat function with either or both of the camper function and the trailer function into a single item. It is also highly desirable to provide a new and improved amphibious unit having multiple functions in order to reduce the space required for storage of multiple items having camper, boat and trailer functions, respectively.

Boats and other floating devices used to enjoy the great outdoors have been used to navigate small and large bodies of water alike. However, recreational boats used for this purpose are not generally designed for use on water for extended periods of time. As a result, people enjoying water sports or the general atmosphere of floating along in the water with their boats must at some point dock the boat, bring it to shore, or otherwise park the boat so that its passengers can disembark to take care of matters that the boat is not well suited for. Otherwise, the boat users must create make-shift living accommodations that are not ordinarily included in boats used for recreation or on camping trips unless the boat is a houseboat or other custom designed boat of some kind. Specifically, on camping trips to which a boat of some kind is taken along, those people on the trip camp on land, engaging in water recreation with the boat during parts of the day, returning to land at least at night in order to sleep if not during the day for various other reasons. As a result, it is highly desirable to provide a new and improved amphibious unit that has accommodations that can be used for camping purposes both on the water and on land. It is also highly desirable to provide a new and improved amphibious unit with living accommodations usable on water and on land that can be as sparse or as lavish as found on any camper unit which customarily has been confined to use only on land.

In order to launch a recreational boat into the water from its trailer or to load a boat from the water back onto a trailer, a great deal of strength, coordination, effort, timing, and experience is required among multiple persons in order to effect the proper positioning of boat and trailer in these tasks. If any of these is missing, the persons involved incur the risk of damaging the boat and/or the trailer, and of injuring themselves or others. Thus, it is highly desirable to provide a new and improved amphibious unit that may be launched into the water or removed from the water by one or only a few people with relative ease and little effort. It is also highly desirable to provide a new and improved amphibious unit that combines the boat and trailer into a single unit such that in order to launch the unit to water requires simply unhitching the trailer portion of the unit from the vehicle after it is positioned down a boat ramp, and such that in order to remove the unit from the water requires simply positioning the unit up a boat ramp far enough to hitch it to a vehicle to complete the removal.

Amphibious units such as the one disclosed herein are most desirable if they are manufactured of materials that make them durable on water as well as on land. As a result, it is highly desirable to provide a new and improved amphibious unit manufactured of marine grade materials for maximizing the durability of the trailer function, the boat function, and the camper function of the unit.

Finally, it is highly desirable to provide a new and improved amphibious unit having all of the above identified features.

### SUMMARY OF THE INVENTION

It is therefore an object of the invention to provide a new and improved amphibious unit.

It is also an object of the invention to provide a new and improved amphibious unit that combines the camper function, the boat function and the trailer function into a single item.

It is also an object of the invention to provide a new and improved amphibious unit having multiple functions in order to reduce space required or storage of multiple items having camper, boat, and trailer functions, respectively.

It is also an object of the invention to provide a new and improved amphibious unit that has accommodations that can be used for camping purposes both on the water and on land.

It is also an object of the invention to provide a new and improved amphibious unit with living accommodations usable on the water or on land that can be as sparse or as lavish as any camper unit may have which customarily has been confined to use only on land.

It is also an object of the invention to provide a new and improved amphibious unit that may be launched into the water or removed from the water by one or only a few people with relative ease and little effort.

It is also an object of the invention to provide a new and improved amphibious unit that combines the boat and trailer into a single unit such that to launch the unit into the water requires simply unhitching the trailer portion of the unit from the vehicle after it is positioned down a boat ramp, and such that to remove the unit from the water requires simply rolling the unit up a boat ramp far enough to hitch it to a vehicle for complete removal.

It is also an object of the invention to provide a new and improved amphibious unit manufactured of marine grade materials for maximizing the durability of the trailer function, the boat function, and the camper function of the unit.

It is finally an object of the invention to provide a new and improved amphibious unit having all of the above identified features.

In the broader aspects of the invention there is provided a new and improved amphibious unit comprising a float, a trailer frame, and a camper, all interconnected with one another. The float has a top and a bottom, and the trailer frame may be secured to the bottom of the float or it maybe an integral part of the float. The trailer frame generally has a tongue and hitch for connecting the unit to a vehicle for transportation over land. The camper is secured to the top of the float, the camper comprising a dwelling operable for camping purposes, including accommodations as sparse or as lavish as appropriate for the overall design of the amphibious unit. The camper may be a conventional pop-up style camper, or it may be a multi-walled structure with a roof and windows for enclosing the living space of the interior of the camper.

### BRIEF DESCRIPTION OF THE DRAWINGS

The above mentioned and other features and objects of the invention and the manner of attaining them will become more apparent and the invention itself will be better understood by reference to the following description of an embodiment of the invention taken in conjunction with the accompanying drawings wherein:

FIG. 1 is a perspective view of a new and improved amphibious unit of the invention having two spaced apart floats, a pop-up roof, roll down windows removably attached, and leveling jacks;

FIG. 2 is a side view of the new and improved amphibious unit shown in FIG. 1 in its down position;

FIG. 3 is a perspective view of the new and improved amphibious unit of the invention with its pop-up roof in the up position and its roll up windows in the rolled up position, its unitary hull and a shadow of the tongue and hitch in the up position forming a bumper therefore;

FIG. 4 is a partial rear view showing one way of connecting a pontoon float to a top platform, and one way of connecting a support beam to a pontoon float of the new and improved amphibious unit of the invention;

FIG. 5 is a bottom view of the float and trailer frame assembly of the new and improved amphibious unit of the invention;

FIG. 6A is a fragmentary side view of a wheel assembly of the new and improved amphibious unit connected to a trailer frame or pontoon;

FIG. 6B is a fragmentary side view of a wheel assembly of the new and improved amphibious unit connected to the trailer frame or pontoon showing both the spring and shock absorber;

FIG. 7A is a side view of an embodiment showing the hinged connection of the tongue to the cross bar of the trailer frame, with the tongue in the prone position;

FIG. 7B is the same as FIG. 7A with the tongue in the upright position forming a bumper as shown in dashed lines in FIG. 3;

FIG. 8 is a perspective view of the new and improved amphibious unit having a pop-up roof showing the pop-up supports in the down position with the roof removed for better viewing, showing one version of a motor and steering console and a unitary float;

FIG. 9 is a perspective view of the new and improved amphibious unit having a dwelling with rigid interconnecting walls on spaced pontoon floats;

FIG. 10 is a bottom view of the float and trailer frame of the new and improved amphibious unit showing the floats with outside wheel wells used as the support beams of the trailer frame; and

FIG. 11 is a top view of the new and improved amphibious unit shown in FIG. 10 with inside wheel wells and the camper platform removed for easy viewing.

### DESCRIPTION OF A SPECIFIC EMBODIMENT

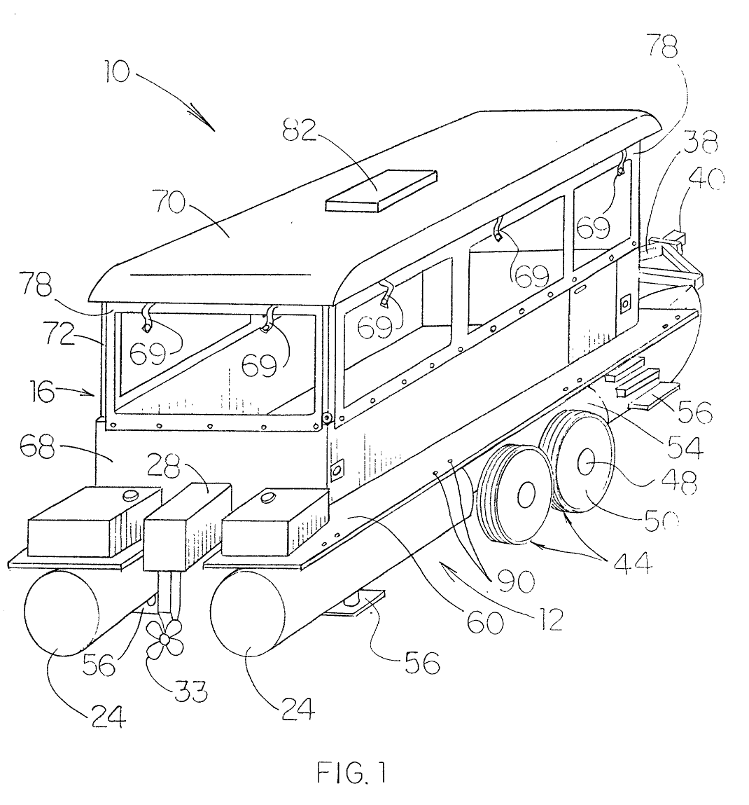

FIGS. 1-11 illustrate the new and improved amphibious unit of the invention. FIGS. 1-3 show an amphibious unit 10 comprising a float 12 having a trailer frame 14 and a camper 16 secured thereto. The float 12 has a top upwardly facing surface 18 and sufficient buoyancy to keep the top surface 18 above water level when the amphibious unit 10 is inserted into a body of water. A trailer frame 14 is secured to the float 12, and a camper 16 is secured to the top 18 of said float, whereby the unit 10 may navigate a body of water, be transported across land, or be used for camping purposes on water or on land, such that the unit 10 obviates the need of the user to have distinct items that must be separately procured, stored, and/or maintained in order to transport a boat, utilize a boat, and go camping.

The float 12 of the amphibious unit 10 can be any buoyant structure suitable for the purposes of floating in and/or navigating a body of water. FIG. 1 shows dual hulls; FIG. 3 shows a single unitary hull. The trailer frame 14 can be any framework or portion thereof that can be outwardly applied to or incorporated with the float for purposes of transporting the float 12. The camper 16 can be any structure capable of defining a space for living or operating accommodations for persons using the unit 10. In a specific embodiment, the unit 10 comprises a float 12 and a trailer frame 14 connected thereto. In other specific embodiments, the unit 10 comprises a float 12 with a camper 16 connected thereto.

In a specific embodiment, the float 12 comprises one or more pieces of polyurethane, polystyrene, or other suitable compositions of foam in fixed relation or spaced array appropriate for securing a camper 16 and/or a trailer frame 14 thereto. In other specific embodiments, the float 12 may comprise any single or multiple hull boat of conventional manufacture. In other specific embodiments, the float 12 comprises one or more elongated, spaced apart floats aligned generally parallel to one another. In other specific embodiments, the float comprises two or more pontoon boat floats 24 in fixed relation and parallel alignment. In yet other specific embodiments, the float comprises a conventional pontoon boat having a motor 28 and/or steering system 30.

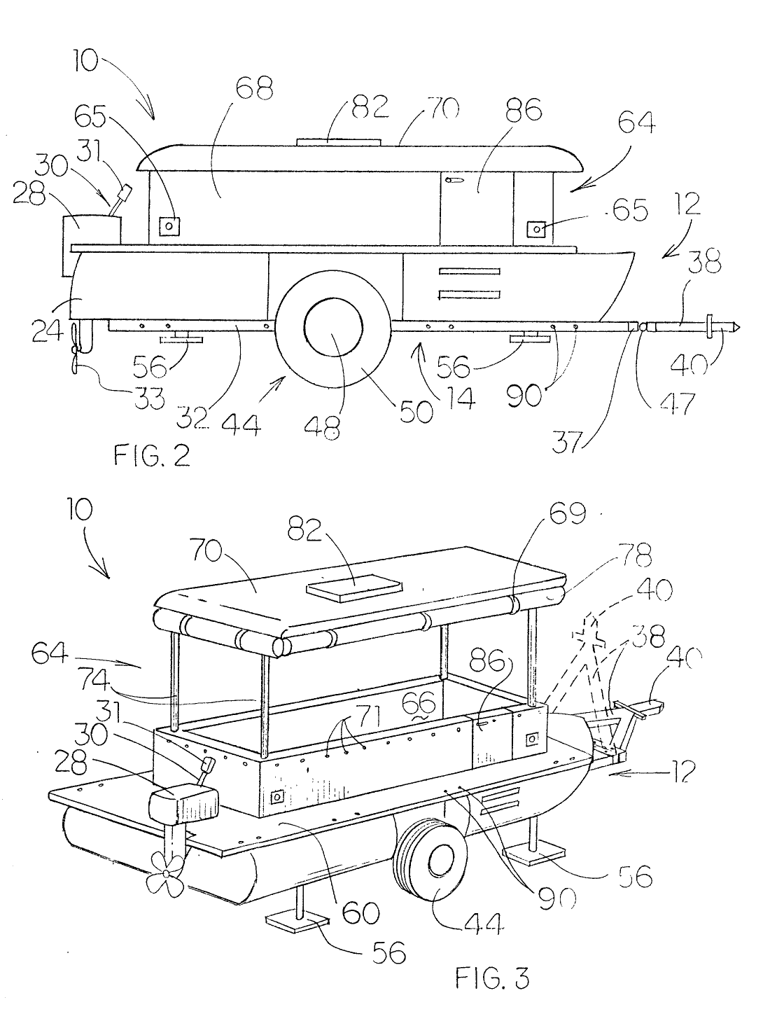

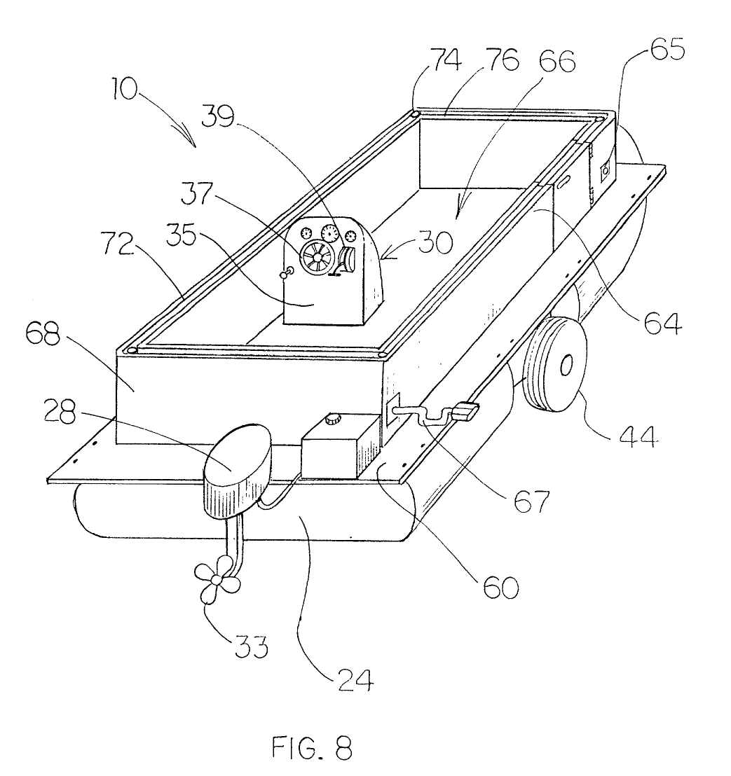

In a specific embodiment, the steering system 30 comprises any means sufficient to orient the motor 28 in order to control the direction of the amphibious unit as it navigates a body of water. FIGS. 2 and 3 show a specific embodiment of the steering system 30 whereby a handle 31 is connected to the motor 28 for swiveling the motor about an axis, causing the propeller 33 to turn and, thus, navigate the amphibious unit in the desired direction. Turning the handle 31 to the left causes the amphibious unit to turn to the right, and vice versa. FIG. 8 shows another specific embodiment of the steering system 30 comprising a console 35 with a steering wheel 37, a means for controlling the swivel of the motor 28 and/or propeller 33, and a throttle 39, having a means for controlling the power output of the motor 28, which is used to navigate the amphibious unit as well as control its speed. In other specific embodiments, the steering wheel 37 controls the swivel by a mechanical or hydraulic connection.

In an amphibious unit that includes a trailer frame 14 secured to the float 12, the trailer frame 14 may comprise a distinct framework secured to the underside of the float 12 for supporting the float as it is transported across land. In a specific embodiment, the distinct framework of the trailer frame 14 is manufactured of marine grade materials. In other specific embodiments, the trailer frame 14 comprises a conventional trailer frame specifically configured to match the float to which it is secured. In other specific embodiments, the trailer frame 14 is any framework designed to accommodate the transportation of the float across land, which also does not substantially hinder the navigability of the amphibious unit in a body of water.

Now referring to FIG. 5, the new and improved amphibious unit 10 is shown to have a trailer frame 14 that comprises spaced apart first and second support beams 32 having generally parallel alignment, which support beams are secured to the float 12, and which have a cross bar 34 extending between and secured to the front end 36 of each support beam. A tongue 38 is connected to the cross bar 34, extending longitudinally from the cross bar in the opposite direction from the support beams 32. The tongue 38 comprises any structure appropriate for supporting a hitch mechanism 40 for connecting the amphibious unit 10 to a vehicle for transportation. At least one wheel assembly 44 is connected to each support beam 32 to enable the unit 10 to be transported across land when pulled by a vehicle. In other specific embodiments, tongue 38 is secured to the rear of a vehicle and connected between the tongue 38 and crossbar 34 is made by means of a ball secured to crossbar 34 or in other conventional means. In other specific embodiments, conventional fifth wheel hitches may be used.

In a specific embodiment, the tongue 38 is connected to the cross bar 34 with a means for allowing the tongue to fold up against the front of the amphibious unit, or in other embodiments against the rear of a vehicle. This means can be any conventional design for permitting radial movement of one element in relation to another element, such as a hinge. Referring now to FIGS. 7A and 7B, a specific embodiment of a means for connecting the tongue 38 to the cross bar 34 is shown. FIG. 7A shows the tongue 38 in the prone position extending longitudinally from the cross bar generally parallel to the support beams 32. FIG. 7B shows the tongue in the folded up position perpendicular to the plane of the support beams to form a bumper 51. In the embodiment of FIGS. 7A and 7B, a stop plate 41 is secured to the cross bar 34. A fixed hinge plate 43 is secured to the stop plate 41. A swinging hinge plate 45 is secured to the tongue 38. A latch 92 is slidingly received by tongue 38. A pivot pin 47 is positioned between the fixed hinge plate 43 and the swinging hinge plate 45. Each hinge plate is connected to the pivot pin by U-bolts 49 which serve as eyelets for sliding the pivot pin 47 in place between the hinge plates when the tongue 38 is in the prone position, as in FIG. 7A. The stop plate 41 prevents the tongue from swinging below the plane of the tongue in the prone position by contacting the swinging hinge plate 45 as shown in FIG. 7A. Similarly, latch 92 is slid from its retracted position shown in FIG. 7 which allows tongue 38 to move into its folded position to its extended position in which it engages cross bar 34 to hold tongue in its prone position. Although FIGS. 7A and 7B show a specific embodiment for connecting the tongue 38 to the cross bar 34 to allow the tongue to fold up against the front of the amphibious unit, such a connection can also be accomplished by other hinge designs.

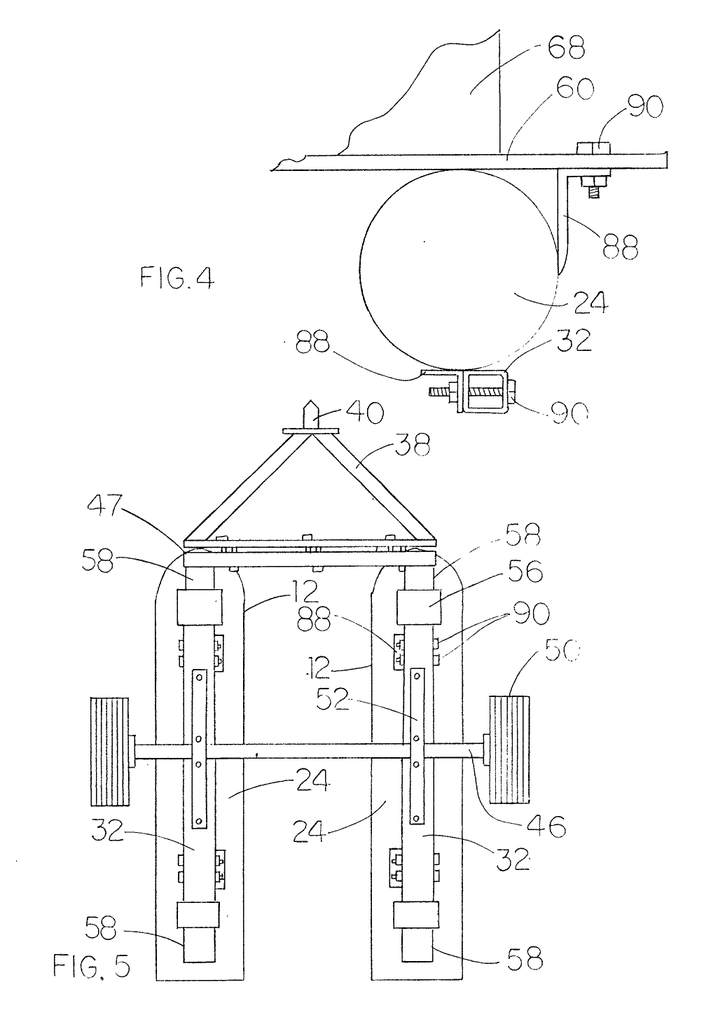

In a specific embodiment, the support beams may be secured to the float 12 by any means sufficient to ensure the durable connection of the support beams to the float in a manner that will endure the use of the amphibious unit on land and in water. Referring now to FIGS. 4 and 5, the support beams 32 of the trailer frame 14 are connected, in a specific embodiment, to the float 12 by a plurality of angle flanges 88 secured to the bottom of the float 12. The angle flanges 88 may be secured to the float 12 by any sufficient means for permanently affixing the angle flange to the float, such as by adhesives or welding. The support beams 32 are secured to the angle flanges 88 by a series of discrete connectors, such as threaded nuts and bolts 90.

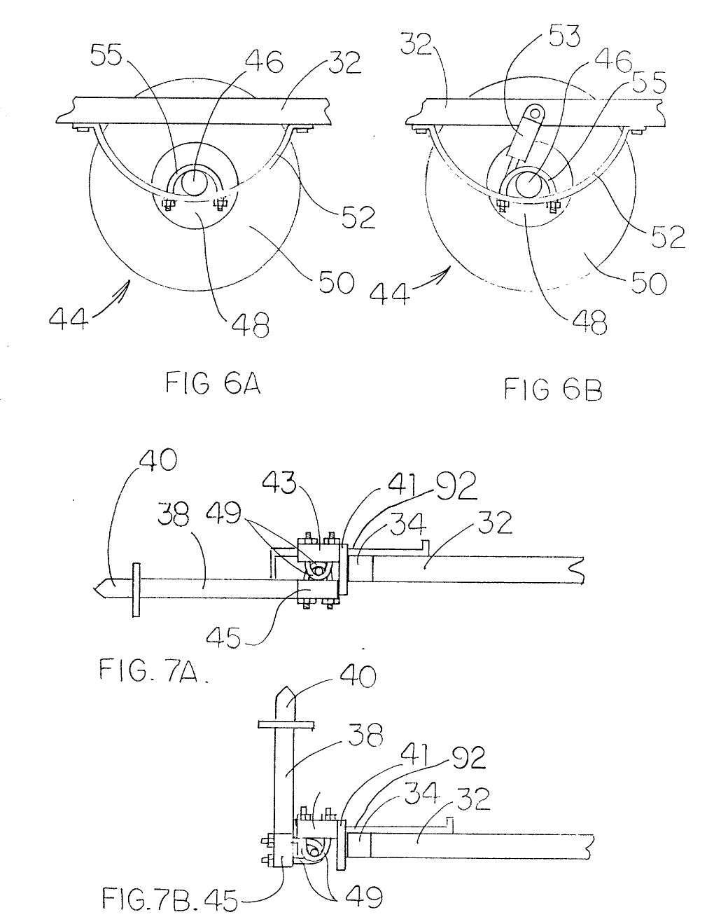

In a specific embodiment, the wheel assembly 44 on one support beam 32 corresponds to a wheel assembly on the opposite support beam. In yet other specific embodiments, the wheel assemblies 44 corresponding to one another are connected by an axle 46 extending between the support beams 32. In other specific embodiments, the wheel assembly 46 comprises a wheel 48 with a tire 50 secured therearound, the wheel 48 being connected to the axle 46. Referring now to FIGS. 6A and 6B, in a specific embodiment, each wheel assembly 44 is connected to a support beam 32 by springs 52 or by springs 52 and shock absorbers 53 whereby shock forces exerted on the trailer frame 14 as a result of the amphibious unit 10 being transported over undulating or uneven terrain are absorbed. In FIG. 6A, the spring 52 is secured to the support beam 32. The axle 46 is connected to the spring by a U-bolt 55 that clamps the axle in a fixed position on the spring. In FIG. 6B, a shock absorber 53 is added to the spring for increased shock absorption. The shock absorber 53 extends between the support beam 32 and the spring 52 on one side of the U-bolt 55. The shock-absorbing connection of the wheel assembly to the support beam can, in other embodiments, comprise conventional coil springs, alone or in combination with the spring 52and/or a shock absorber 53. In all embodiments, wheel assemblies 44 are the lowest extending portion of trailer frame 14 or float 12. Thus, wheel assemblies 44 allow the amphibious unit 10 to traverse shallow ponds as the float will never ground as the wheel assemblies 44 will first touch the bottom of any shallow portion of any pond or lake allowing the amphibious unit 10 to be moved either into deeper water or onto the shore and connected to a vehicle for land transportation.

In other specific embodiments, as shown in FIGS. 1 and 9-11, the float 12 has a plurality of wheel wells 54 wherein the wheel assemblies 44 are positioned when the trailer frame 14 is secured to the float 12. In other specific embodiments, the float 12 has no wheel wells, thus requiring each wheel assembly of the trailer frame to extend outward, as shown in FIG. 5, or downward from the float 12 and trailer frame 14 in order to allow sufficient clearance from the amphibious unit 10 for the wheel assemblies to operate properly.

In other specific embodiments, multiple leveling jacks 56 are connected to the trailer frame 14 to adjust the level of the float 12 as the unit 10 sets on uneven or undulating terrain. The j jacks 56 are positioned in a way to maximize the benefit of the leveling action. In a specific embodiment, four leveling jacks 56 are secured to the underside of the support beams 32, one at each corner 58 of the trailer frame 14. FIG. 2 shows leveling jacks 56 in an up position. FIG. 3 shows the leveling jacks 56 engaged with a ground surface to level the amphibious unit 10. In specific embodiments, jacks 56 may be scissor jacks, screw jacks, hydraulic jacks or any other conventional jacks, hydraulically or electrically powered.

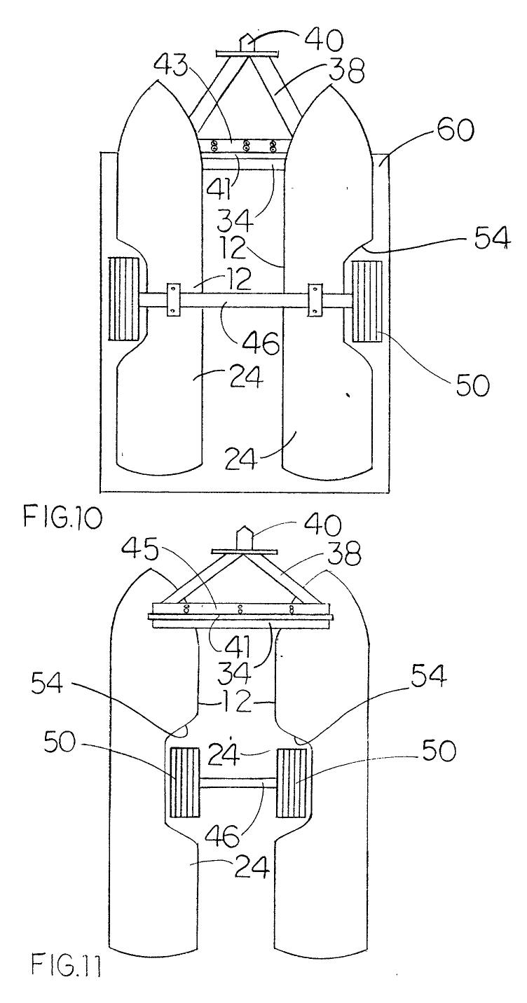

Referring now to FIGS. 10 and 11, a new and improved amphibious unit 10 is shown with a trailer frame 14 that comprises the float 12 and multiple elements including the tongue 38, crossbar 34, stop 41, and fixed hinge plates 43, 45 secured to the float 12, rather than the distinct framework including the beam 32 shown in FIG. 5, such that the support beams 32 are eliminated and the float 12 itself is the load bearing structure member of the trailer frame 14. The multiple elements are secured to the float 12 in order to render the unit 10 transportable by connecting it to a vehicle 42. In a specific embodiment, a tongue 38 with a hitch 40 is secured to the front end 36 of the float 12 and opposing wheel assemblies 44 are connected to the midsection float 12 to enable transportation across land when the hitch 40 is connected to a vehicle. In yet other specific embodiments, the wheel assemblies 44 are connected to float 12 by an axle 46 secured to the float 12 as shown in FIG. 10. Axle 46 is secured to the float 12 in specific embodiments as illustrated in FIG. 10. Wheel assemblies 44 are mounted on the axle 46 for rotation either in wheel wells 54 on the opposite exterior sides of the pontoons as shown in FIG. 10, or in wheel wells 54 on the facing sides of the pontoons interior of the pontoons or floats 12 as shown in FIG. 11. In most cases, the size of the float 12 or the pontoons dictate where the wheels are to be mounted so as to comply with both state and federal requirements for trailers to be hauled along roads and highways. In most cases, the width of any vehicle to be hauled along a roadway or highway without wide load provisions is believed to be ninety-six inches. Thus, when the float or floats 12 have a transverse dimension of ninety-six inches, the wheel assemblies 44 must be positioned within the floats 12 and the wheel wells 54 must be dimensioned so as to provide the requisite stability of the amphibious unit 10. In a specific embodiment not shown, the wheel assemblies 44 may be affixed to the under side of the deck of the boat instead of the float as shown in FIGS. 10 and 11 by means of a U-shaped axle in which the central portion of the “U” is secured to the under side of the decking and the two legs of the axle each support a wheel assembly 44. In other specific embodiments, the float 12 has first and second wheel wells 54 wherein the wheel assemblies 44 are positioned. In yet other specific embodiments, the wheel assemblies 44 are connected to the float 12 by spring mechanisms such as spring 52 or springs 52 and shock absorbers 53. In other specific embodiments, multiple leveling jacks 56 are secured to the underside of the float 12.

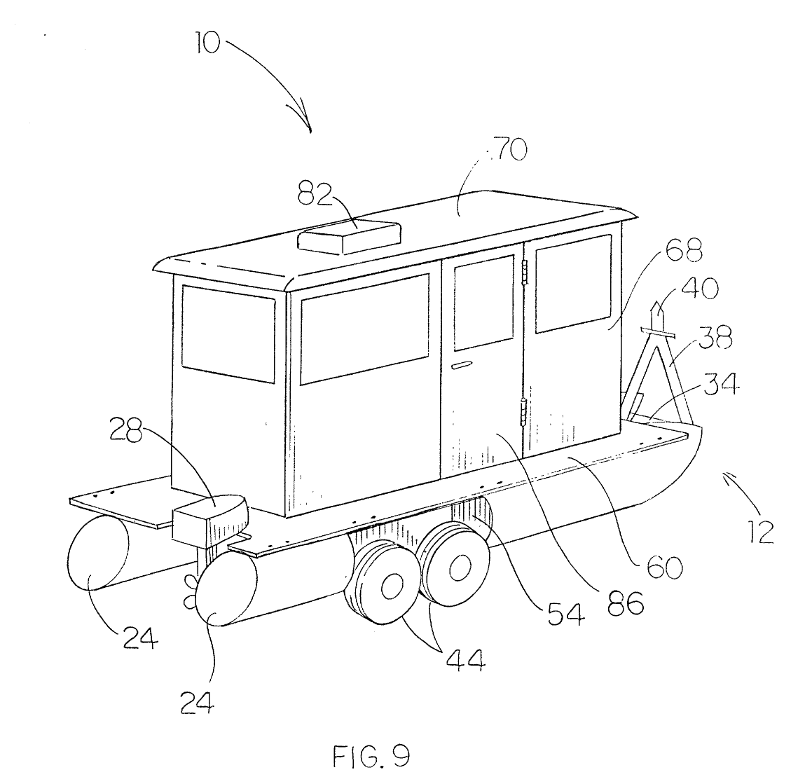

Now referring to FIG. 9, the new and improved amphibious unit 10 is shown with a dwelling 62 secured to floats 12. The unit 10 comprises a platform 60 mounted to the top 18 of the floats 12 and a dwelling 62 mounted on the platform 60, such that the dwelling 62 may be operable for camping purposes as the unit 10 sets in a body of water or on land. In yet other specific embodiments, the dwelling 62 has an interior space 66 where users of the unit 10 may utilize the dwelling 62 for living arrangements while camping, operate and/or navigate the unit as it sets in a body of water, or both. In a specific embodiment, the dwelling 62 is manufactured of marine grade materials. The platform 60 may be mounted to the top 18 of the floats 12 by any means sufficient to ensure the durable connection of the platform to the float in a manner that will endure the use of the amphibious unit on land and in water. Referring now to FIG. 4, in a specific embodiment, the platform 60 is connected to the float 12 by a plurality of angle flanges 88 secured to the float. The angle flanges 88 may be secured to the float 12 by any means sufficient to permanently affix each angle flange to the float, such as by adhesives or welding. The plurality of angle flanges 88 secured to the float 12 are removably secured to the platform 60 by a plurality of discrete connectors, such as threaded nuts and bolts 90.

Referring now to FIGS. 1-3 and 8, in a specific embodiment, the camper 16 comprises a conventional pop-up style camper 64, comprising a plurality of interconnected walls 68 extending vertically upward from the periphery of the platform 60 such that the walls define an interior space 66. In a specific embodiment, the interconnecting walls 68 of the camper 64 have a height of between 3 and 7 feet, and support a collapsible or removable framework 72 of vertical elements 74 and/or horizontal elements 76 that define a space for a roof 70 and multiple spaces for windows 78. A hood or removable rigid top 80 may extend horizontally across the framework 72 to create the roof 74 enclosing the interior space 66 of the camper 64. In a specific embodiment, the roof 70 comprises a hood manufactured of a flexible sheet material that is durable, waterproof, mildew resistant and wind resistant. In other specific embodiments, a rigid roof 70 is connected to the vertical and/or horizontal elements 74,76, and maybe manufactured of any durable and lightweight material such as fiberglass or aluminum. In other specific embodiments, the roof 70 is manufactured of marine-grade materials.

In a specific embodiment, the vertical elements 74 of the framework 72 are connected to the comers of the interconnected walls 68 by a means for raising and lowering the vertical elements from a position within the interconnecting walls. In one specific embodiment, the vertical elements 74 comprise posts that are raised and lowered from within the interconnected walls by a hand crank arrangement comprising a socket 65 secured to a wall or a motorized electrical arrangement. In the hand crank version, the vertical element 74 is raised and lowered by using a socket winch 67 inserted into the socket 65 and wound one direction for raising and the opposite direction for lowering the vertical element.

In the embodiment shown in FIGS. 1 and 3, the pop-up style camper has windows 78 manufactured of flexible sheet material that is durable, waterproof, mildew resistant, and wind resistant, which are removably connected to the framework 72. The windows 78 may be rolled up as shown in FIG. 3 and held in the rolled up position by a plurality of straps 69. As shown in FIG. 1, the windows 78 are in a rolled-down position and removably connected to the interconnected walls of the pop-up camper 64 by a plurality of discrete fasteners 71. In a specific embodiment, the discrete fasteners may be snaps, Velcro®, zippers or any other fastener sufficient to secure the bottom of the windows 78 to the tops of the interconnected walls 68.

Referring now to FIG. 9, the dwelling 16 comprises a plurality of interconnected walls 68 extending vertically upward from the periphery of the platform 60 such that the walls define the interior space 66. The amount of vertical extension of the walls 68 can be to any height sufficient for defining the interior space 66. In the specific embodiment of FIG. 9, the height of the walls 68 can be any height sufficient for use of the dwelling 16 by occupants of normal adult height. In other specific embodiments, the height of the walls 68 is between 7 feet and 10 feet. In other specific embodiments, the interconnecting walls 68 additionally have a rigid roof 70 for enclosing the interior space 66 of the camper 16 to shield the interior space from atmospheric elements.

The new and improved amphibious unit 10 of the invention comprises a camper 16 having a dwelling 62 that is capable of providing living accommodations in a wide range of amenities. In a specific embodiment, the dwelling is capable of providing amenities including any or all of a sink a toilet or septic system, a shower, a stove, a power generator, a heater, a refrigerator, a drinking water system, an air conditioning system 82, and sitting and sleeping arrangements including slide-out style or trundle beds and fold-out couch style beds. In a specific embodiment, the accommodations available in the dwelling 16 are in addition to the steering system 30 of the float 12 for navigating the amphibious unit 10 on water. In operation, the new and improved amphibious unit 10 of the invention functions as any other trailer, boat or camper unit. Because of the unit 10's unique combination of camper unit, floats and trailer assembly, the new and improved amphibious unit 10 of the invention can be both hauled as a trailer behind a vehicle along roads and highways to the location where it is to be used or stored. The new and improved amphibious unit 10 of the invention when floating is maneuverable in all ways that like boats are maneuverable.

In most specific embodiments of the new and improved amphibious unit 10 of the invention, the unit has a buoyancy such that the water line is located approximately half way between the bottom of the float 12 and the top of the float. This water line is, in a specific embodiment, supported by the wheel assemblies 44 on a road or highway approximately twenty-four inches above the road. Thus, the wheel assemblies 44 are the lowest portion of the new and improved amphibious unit 10 of the invention. In most specific embodiments, the propeller of the motor 28 is supported above the ground at least eight inches. In most specific embodiments, the jacks 56 have a thirty-two inch travel such that set with the jacks 56 fully extended, the wheel assemblies 44 may be supported from a road or campsite approximately eight inches from the ground. In a specific embodiment, the new and improved amphibious unit 10 of the invention has the advantage over other boats in that it may be safely used in shallow water areas in which the bottom configuration is not known as the wheel assemblies 44 will be the first to touch the bottom and the motor 28 will always be protected from the bottom.

The new and improved amphibious unit of the invention provides a new and improved amphibious unit combining the functions of camper, boat, and trailer into a single item. This combination obviates the need to have multiple items that individually provide these functions. The new amphibious unit additionally reduces the space required for storage of such multiple items. The new amphibious unit has accommodations that may be used for camping purposes both on land and on water. The accommodations for camping purposes of the amphibious unit can be as sparse or as lavish as any camper unit may have which customarily has been confined to use only on land. The combination of functions of the amphibious unit provides a unit that may be launched into the water or removed from the water by one or only a few people with relative ease and little effort. The relative ease and little effort for launching and removing the amphibious unit of the present invention requires simply unhitching the trailer portion of the unit from the transporting vehicle after it has positioned the unit down a boat ramp, or simply rolling the unit up to a boat ramp far enough to hitch the unit to the transporting vehicle for complete removal. The new amphibious unit disclosed herein is more desirable when manufactured of marine grade materials for maximizing the durability of the trailer frame, the float, and the camper. Finally, the new and improved amphibious unit disclosed herein provides all of the above identified features.

While a specific embodiment of the invention has been shown and described herein for purposes of illustration, the protection afforded by any patent which may issue upon this application is not strictly limited to the disclosed embodiment; but rather extends to all structures and arrangements which fall fairly within the scope of the claims which are appended hereto:

What is claimed is:

1. An amphibious trailer comprising a float having a top upwardly facing surface, and a trailer hitch connected to said float, said float having sufficient buoyancy to keep said top of said float above the level of water when said float and said trailer hitch are inserted into a body of water, said connected float and trailer hitch being able to navigate a body of water or be transported across land by connecting said trailer hitch to a vehicle.

2. The amphibious trailer of claim 1 wherein said float comprises a buoyant structure selected from the group consisting of a piece of foam, an interconnected plurality of pieces of foam, a single hull boat, a double hull boat, and a pontoon boat.

3. The amphibious trailer of claim 1 wherein said float comprises a plurality of elongated, spaced apart floats having generally parallel alignment, each of said floats having a rear end, and at least one engine unit mounted to said rear end of said float.

4. The amphibious trailer of claim 3 wherein said plurality of elongated floats comprises a pair of pontoon floats.

5. The amphibious trailer of claim 3 having a plurality of braces connecting said floats at said rear end, said engine unit being mounted to said braces.

6. The amphibious trailer of claim 1 further comprising a trailer frame having spaced apart first and second support beams in generally parallel alignment, each of said support beams having a top, a bottom, a front end and a rear end, at least one cross bar extending between and secured to said front ends of said support beams, a tongue secured to said cross bar, a hitch secured to said tongue, said tongue and said support beams extending longitudinally in opposite directions from said crossbar, at least one axle extending between said support beams, each said axle having a first end and a second end, a pair of springs extending between said axle and support beams, and first and second wheel assemblies connected to said first and second ends of said axle respectively, said trailer frame being connected to said float at said top of said support beams.

7. The amphibious trailer of claim 6 wherein said trailer frame further comprises four leveling jacks, said leveling jacks being connected to the four comers of said trailer frame, respectively, said jacks being moveable vertically for supporting said support beams irrespective of said wheel assemblies.

8. The amphibious trailer of claim 6 wherein said spring assembly includes shock absorbers, whereby shock forces exerted on said trailer frame as a result of said amphibious trailer being transported over undulating or uneven terrain are absorbed.

9. The amphibious trailer of claim 6 wherein said float has first and second wheel wells for each said axle, said wheel and said tire of said wheel assemblies being positioned within said wheel wells.

10. An amphibious trailer comprising a float having a top upwardly facing surface, a tongue secured to said float, a hitch connected to said tongue, said tongue extending outwardly from said float, at least one axle connected to said float, and a first and second wheel assemblies for each said axle, said wheel assemblies being rotatably connected to the opposite ends of each said axle, said float having sufficient buoyancy to keep said top of said float above the level of water when said amphibious trailer is inserted into a body of water, said amphibious trailer being able to navigate said body of water or be transported across land by connecting said hitch to a vehicle.

11. The amphibious trailer of claim 10 wherein said float further comprises a plurality of spaced apart support beams, said support beams being generally parallel, each said support beam having a top, a bottom, a front end and a rear end, a cross bar extending between and secured to said front ends of said support beams, a tongue secured to said cross bar, a hitch secured to said tongue, said tongue and said support beams extending longitudinally in opposite directions from said cross bar, an axle extending between said support beams having a first end and a second end, a first and second wheel each with a tire secured therearound, said first of said wheels being rotatably connected to said first end of said axle, said second of said wheels being rotatably connected to said second end of said axle, a first and second spring assembly, said spring assemblies being connected between said first or second support beams and said axle, said spring assemblies absorbing shock forces exerted on said trailer frame as a result of said amphibious trailer being transported over undulating or uneven terrain, a plurality of leveling jacks, said leveling jacks being connected to the periphery of said trailer frame respectively, said jacks being moveable vertically for supporting said float when the amphibious trailer is at rest on terrain, said trailer frame being connected to said float at said top of said support beams.

12. An amphibious trailer comprising a float having a top upwardly facing surface, a trailer frame connected to the bottom of said float, and a camper connected to the top of said float, said float having sufficient buoyancy to keep said top of said float above the level of water when said connected float and trailer frame are inserted into a body of water, said amphibious trailer being able to navigate a body of water or be transported across land by connecting said trailer frame to a vehicle.

13. The amphibious trailer of claim 12 further comprising a flat platform having a top and a bottom, said platform being mounted horizontally on said top of said float, and a dwelling mounted on said top of said platform, said dwelling being operable for camping purposes as said amphibious trailer sets in a body of water or on land.

14. The amphibious trailer of claim 13 wherein said dwelling comprises a plurality of interconnected walls extending vertically upward from the periphery of said platform, each of said walls having a top, and a roof connected to said top of each said wall.

15. The amphibious trailer of claim 13 wherein said dwelling comprises a plurality of interconnected walls extending vertically upwardly from said top of said platform, each said wall having a top, and framework removably connected to said top of each said wall, said framework having a plurality of vertical frame elements extending from said walls and horizontal frame elements extending between adjacent one of said vertical elements, a roof extending horizontally across said framework, said roof being removably connected to said horizontal elements, and a plurality of side pieces removably connected to said framework, each said side pieces draping vertically downwardly from said horizontal elements between each said vertical element to said top of said walls.

16. The amphibious trailer of claim 15 wherein said side pieces and said roof are made of a flexible material that is durable, waterproof, mildew resistant, and wind resistant.

17. A amphibious trailer comprising a pair of spaced apart pontoon floats, each float having a top, a bottom, and a rear end, said floats having generally parallel alignment, a motor support connecting said top of said floats at said rear end, an engine unit mounted on said motor support, a cross bar extending between said front ends of said floats, a tongue secured to said cross bar, a hitch, secured to said tongue, said tongue and said floats extending longitudinally in opposite directions from said cross bar, an axle extending between said floats having a first end and a second end, a first and second wheel each with a tire secured therearound, said first wheel being rotatably connected to said first end of said axle, said second wheel being rotatably connected to said second end of said axle, a first and second spring assembly, said spring assemblies being connected between said floats and said axle respectively, said spring assemblies absorbing shock forces exerted on said trailer frame as a result of said amphibious trailer being transported over undulating or uneven terrain, a plurality of leveling jacks, said leveling jacks being connected to the periphery of said floats, respectively, said jacks being moveable vertically for supporting said floats irrespective of said wheel assemblies when the amphibious trailer is at rest on terrain, a flat platform having a top and a bottom, said bottom of said platform being secured to said top of said floats, a plurality of interconnected walls extending vertically upwardly from the periphery of said top of said platform, each said wall having a top, a conventional pop-up style camper top connected to said top of said walls, a roof extending horizontally across said camper top, said roof being removably connected to said camper top, a plurality of side pieces removably connected to said camper top and said top of said walls, said amphibious trailer being able to be transported across land by removably connecting said hitch to a vehicle, said float having sufficient buoyancy to keep said top of said pontoon floats above the level of water when said amphibious trailer is inserted into a body of water, said amphibious trailer being able to navigate a body of water.
